(19) United States
(12) Patent Application Publication
(10) Pub. No.: US 2003/0018831 A1
(43) Pub. Date: Jan. 23, 2003

(54) Application programming interface for providing direct access to a WSP layer of a WAP stack

(76) Inventor: Alberto Juan Martinez Lebena, Santander (ES)

Correspondence Address: Brian D. Walker, Jenkens & Gilchrist, P.C., 3200 Fountain Place, 1445 Ross Avenue, Dallas, TX, 75202-2799, US

(21) Appl. No.: 09/907,185

(22) Filed: Jul. 17, 2001

(51) Int. Cl. G06F 9/46

(52) U.S. Cl. 709/328

(57) ABSTRACT

An application programming interface enables the interfacing of the WSP layer of a WAP protocol stack with an external application environment which may comprise a non-WAP application or a remotely located WAE layer of the WAP protocol stack. A first layer associated with the external application environment maps received external application environment primitives into a transport format for forwarding toward the WSP layer and extracts primitives from the transport format received at the first layer. A second layer associated with the WSP layer maps WSP layer primitives into a transport format for forwarding to the external application environment and extracts primitives from the transport format received at the second layer.

### TECHNICAL FIELD

The present invention relates to the wireless application protocol, and more particularly, to the use of an application programming interface for directly accessing the WSP layer of the wireless application protocol stack.

### BACKGROUND OF THE INVENTION

The wireless application protocol (WAP) architecture is a closed environment only allowing the transfer and execution of WAP applications. The architecture is not configured to use the layers of the stack to transmit applications other than WML and WML script applications, nor are the layers of the stack configured to be in more than a single location. Thus, a WAP configured device is not able to transmit anything other than WAP data. This requires devices transmitting both WAP and non-WAP information to include two separate protocol stacks. Multiple stacks require more space and complexity within a device. Furthermore, some implementations of a wireless application protocol stack might find placement of all layers of the protocol stack within a single location somewhat limiting. For example, an application environment might be located in a first location while the actual wireless transmission modules associated with a WAP stack would be located in a second location. The classic WAP architecture wherein all layers of the WAP stack are located in a single location could not facilitate this type of arrangement.

### SUMMARY OF THE INVENTION

The present invention overcomes the foregoing and other problems with an application programming interface enabling the interfacing of a WSP layer directly with an external application environment. The application programming interface includes a first layer associated with the external application environment for mapping primitives of the external application environment received at the first layer into WSP primitives and into a transport format for forwarding to the WSP layer. Additionally, the first layer extracts primitives of the external application environment from the transport format received at the first layer. A second layer associated with the WSP layer maps primitives of the WSP layer received at the second layer into external application environment primitives and maps the primitives into the transport format for forwarding between the external application environment and the WSP layer. The second layer also extracts primitives of the WSP layer from the transport format received at the second layer.

In a first embodiment of the invention, the application programming interface interconnects a WSP layer of a WAP protocol stack with the WAE layer of the WAP protocol stack, wherein the WAE layer is located at a separate location from the WSP layer. In another embodiment, the external application environment comprises a non-WAP application which may be located in the same or different device as the WSP layer.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates a wireless application protocol stack;

FIG. 2 illustrates a manner in which an application programming interface interfaces the WSP layer of the WAP stack to an external application environment;

FIG. 3 illustrates the interfacing of a non-WAP application environment to the WSP layer of the WAP stack via an application programming interface;

FIG. 4 illustrates the application programming interface between the WSP layer and a non-WAP application environment;

FIG. 5 illustrates the function of the application API within the application programming interface;

FIG. 6 illustrates the conversions of data to a transport format with the application API;

FIG. 7 illustrates the distance API within the application programming interface;

FIG. 8 illustrates the operation of the application programming interface within a single device;

FIG. 9 illustrates the operation of the application programming interface between a wireless module and an external human machine interface,

FIG. 10 illustrates the interconnection of separately located WAE and WSP layers of the protocol stack via an application programming interface; and

FIG. 11 illustrates the application programming interface for integrating separately located WAE and WSP layers.

### DETAILED DESCRIPTION

Referring now to the drawings, and more particularly FIG. 1, where there is illustrated a wireless application protocol WAP stack 10 within a WAP client 15. The WAP stack 10 includes a number of layers for performing the WAP functionalities. The wireless application environment (WAE) 20 is a general purpose application environment based upon a combination of a WAP browser and mobile telephone technologies. The primary objective of the WAE 20 is to establish an interoperable environment that will allow operators and service providers to provide applications and services that can reach a wide variety of different wireless platforms in an efficient and useful manner. The WAE 20 includes a micro browser environment providing the ability to utilize wireless markup language (WML, WML script, wireless telephony application and various content format).

The wireless session protocol layer (WSP) 25 provides the application layer of WAP with a consistent interface to two session services. The first is a connection oriented service that operates above the transaction layer protocol (WTP). The second is a connection-less service that operates above a secure or non-secure datagram service (WDP). The WSP 25 provides services suited for browsing application and currently provides the following functionalities: HTTP/1.1 functionality and semantics in a compact over-the-air encoding, long lived session state, session suspend and resume with session migration, a common facility for reliable and unreliable data push and protocol feature negotiation.

The wireless transaction protocol (WTP) 30 runs on top of a datagram service and provides a lightweight transaction oriented protocol that is suitable for implementation in mobile stations. The WTP 30 operates efficiently over secure or non-secure wireless datagram networks and provides the following features: three classes of transaction services (unreliable one-way requests, reliable one-way requests and reliable two-way request reply transactions), optional user to user reliability, optional out of band data on acknowledgments, PDU concatenation and delayed acknowledgments to reduce the number of messages sent, and asynchronous transactions.

The wireless transport layers security (WTLS) layer 35 is a security protocol based on an industry standard transport layer security (TLS) protocol formerly known as the secure sockets layers (SSL). The WTLS layer 35 is intended for use with the WAP transport protocols and has been optimized for use over narrowband communications channels. The WTLS 35 provides the following features: data integrity, privacy, authentication, and denial of service protection. The WTLS layer 35 may also be used for secure communications between terminals. Applications are able to selectively enable or disable the WTLS layer 35 features depending upon their security requirements and the characteristics of the underlying networks.

The wireless datagram protocol layer (WDP) 40 is the transport layer protocol in the WAP architecture. The WDP layer 40 operates above the data capable bearer services supported by the various network types. As a general transport service, the WDP layer 40 offers a consistent service to the upper layer protocols of WAP and communicates transparently over one of the available bearer services. Since the WDP protocols provide a common interface to the upper layer of protocols the security, session, and application layers are able to function independently of the underlying wireless network. This is accomplished by adapting the transport layers to a specific feature of the underlying bearer. By keeping the transport layer interface and the basic features consistent, global interoperability can be achieved by using mediating gateways.

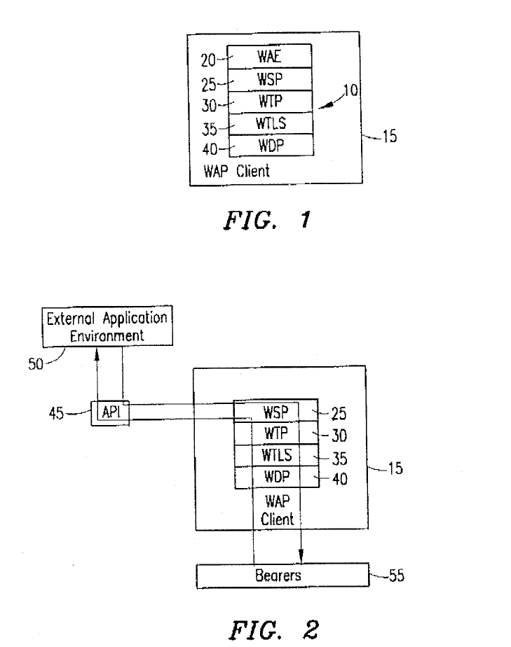

Referring now to FIG. 2, there is provided a general illustration of the present invention wherein an application programming interface (API) 45 is used to interconnect an external application environment 50 directly to the WSP layer 25 of the protocol stack 10. The external application environment 50 has the ability to interface with the WAP stack 10 through the application programming interface 45 and access the bearer services 55. The external application environment 50 may comprise WAP applications, non-WAP applications, the WAE layer 20 or any other type of application or service which might benefit from being able to directly access the WSP layer 25 through the application programming interface 45. The external application environment 50 may be located within a same or separate electronic device.

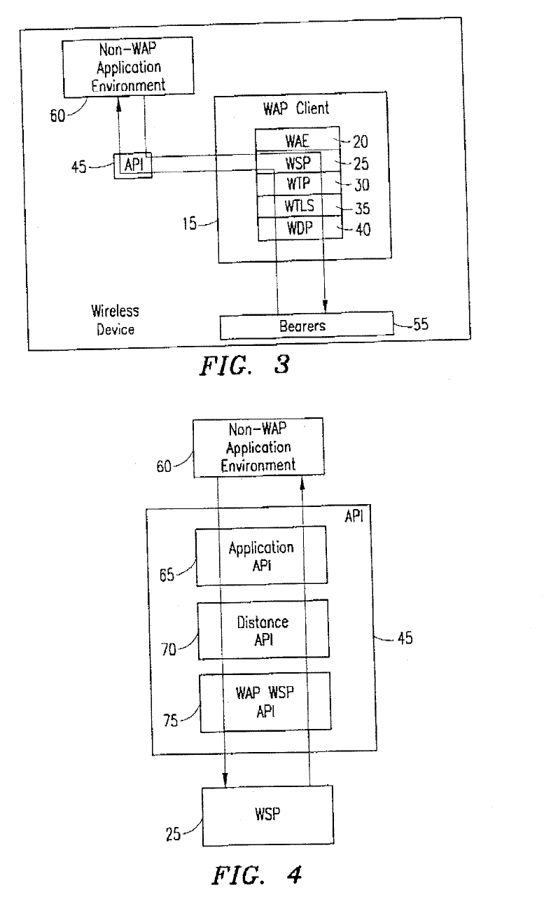

One manner in which the application programming interface 45 could expand the use of the WAP stack 10 is through enabling the WAP stack to transmit non-WAP content between a client and a server. Thus, a non-WAP application could directly access the WSP layer 25 of the WAP stack 10 if the transmitted data were properly formatted. Using this configuration, it would be possible to access an HTML page using part of the WAP stack layers. The application programming interface 45 enables direct data communication between a non-WAP application environment 60 and the WSP layer 25. The application programming interface 45 is needed because the WSP layer can only access the WAE layer 20 and the WTP layer 30. As shown in FIG. 3, use of the application programming interface 45 enables the non-WAP application environment 60 to access the WSP layer 25 of the WAP stack 10 and transmit non-WAP data thereon.

Referring now to FIG. 4, there is more fully illustrated the structure of the application programming interface 45 interconnecting the non-WAP application environment 60 and the WSP layer 25. The API 45 consists of the application API layer 65, the distance API layer 70, and the WAP WSP API layer 75. The API 45 allows communication between a non-WAP application layer 60 and the WSP layer 25. The application API layer 65 enables primitives of the non-WAP application environment 60 to be exchanged with the primitives of the WSP layer 25. Primitives enable communication between differing protocol layers. They comprise the particular instruction language to which the protocols of each of the layers is responsive. Examples of primitives in the WSP layer include S-Connect, S-Disconnect, S-Suspend, S-Resume, S-Method Invoke. The structure of the primitives for the WSP layer 25 is defined within the WAP WSP specification (“Wireless Session Protocol Specification”; WAP Forum; Nov. 5, 1999) which is incorporated herein by reference. The functionality of the application programming interface 45 is symmetric in that the various sublayers of the application programming interface 45 operate in both directions for information travelling from the non-WAP environment 60 to the WSP layer 25 and for information travelling from the WSP layer 25 to the non-WAP application environment 60.

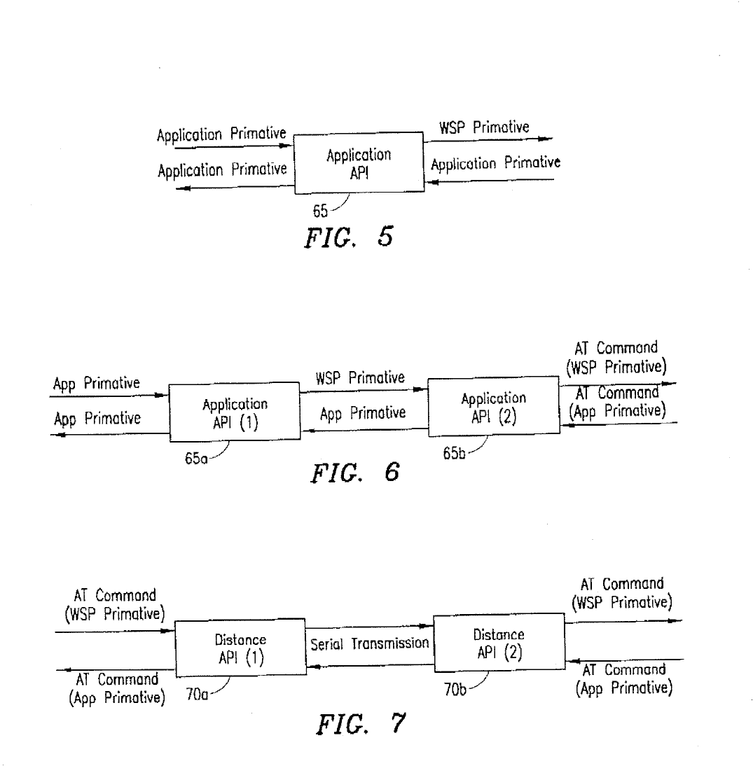

Referring now to FIG. 5, there is more fully illustrated the operation of the application API layer 65. The application API layer 65 maps the application primitives received from the external application environment 60 into WSP primitives. Mapping may occur using a look up table, a defined rule set or other like method. Additionally, the mapped primitives are converted into the right format to be transmitted over the media transmitting to the WSP layer 25. If the external application environment 60 and the WSP layer 25 are in the same device, the application API 65 will place the resulting primitive into a suitable SAP (service access point). If the external application environment 60 and the WSP layer 25 are located in different physical entities, then application API 65 must place the primitives in a suitable format for transmission over whatever type of serial communication link may be used, for example, AT commands or OBEX objects. It should be realized, that any format for transmission of data between the two locations may be utilized.

This process is more fully illustrated in FIG. 6, wherein a second portion of the application API 65b converts WSP primitives into an AT command while the first portion of the application API 65a converts primitives between application primitives and WSP primitives. In the reverse direction for data received at the application layer API 65 coming from the WSP layer 25, the application API 65b extracts the application primitive from, for example, an AT command or OBEX object in which the primitive is embedded. If the external application environment 60 and the WSP layer 25 are within the same physical device, the application API 65 merely extracts the application primitives from the correspondent SAP. The extracted application primitive is then forwarded to the external application environment without further processing.

Referring now also to FIG. 7, there is illustrated the distance API layer 70. The distance API 70 layer is only necessary in situations wherein the external application environment 60 and the WSP layer 25 are located in different devices. In cases where the WSP layer 25 and external application environment 60 are located within the same physical device, the distance API layer 70 does not perform any functionality. The distance API layer 70 comprises two portions, a first portion 70a implemented upon the external application environment 60 and a second portion implemented where the WSP layer 25 resides. When the external application environment 60 and the WSP layer 25 are separately located, the first portion 70a of the distance API 70 receives information coming from the application API and places it within the proper format to be transmitted over a serial link interconnecting the external application environment 60 and the WSP layer 25. For example, if the application API 65 is providing information with AT commands and the external application environment 60 and the WSP layer 25 are communicating via an RS-232 serial link, the distance API layer 70 takes the AT commands and places them in the proper format for RS-232 serial transmission. For data received from the WSP layer 25, the AT commands would be extracted from whatever format (i.e., RS-232) in which the information was embedded for transmission over the serial link to the external application environment 60. In the second portion 70b, the corresponding process occurs in the reverse direction.

The WAP WSP API layer 75 functions in two separate cases. When the external application environment 60 and the WSP layer 25 are located within the same electronic device and the communication comes from the non-WAP application environment, the WAP WSP API layer 75 provides a transparent function that leaves the WSP primitive contacting the WSP entry point as if the primitive were coming from the WAE layer. In the opposite direction, the WSP primitive is mapped into the corresponding application primitive and placed into the corresponding transmission medium (AT commands, OBEX, etc.) before being passed on to the next API layer.

When the external application environment 60 and the WAP WSP layer 25 are located within different entities and the communication comes from the external application environment, the WAP WSP API 75 removes the WSP primitive from the corresponding transmission medium (AT command, OBEX, etc.) and passes the WSP primitive to the WSP layer within the WAP client. For transmissions coming from the WSP layer 25, the WAP WSP API 75 maps between received WSP primitive and the corresponding application primitive and places the application primitive into the proper transmission protocol (AT command, OBEX, etc.) for transmission to the next layer of the application programming interface 45.

While the present discussions refer to an HTML browser using the WAP stack to transmit data, this method may also work with any type of data interpretation program (for example, XHTML browser) or any other program able to work with data transmitted from a remote place (for example, synchronization programs). Referring now to FIG. 8, there is illustrated an implementation of the application programming interface 45 of FIG. 4 wherein an HTML browser 80 and a WSP layer 25 are interconnected within a same wireless device 85 In this case, communications from the HTML browser would be provided to the application API layer 65 and the WAP WSP API layer 75 of the application programming interface 45 to the WSP layer 25 of the WAP protocol stack 10 and onward to the bearers 55. Information back to the HTML browser would pass in the reverse direction.

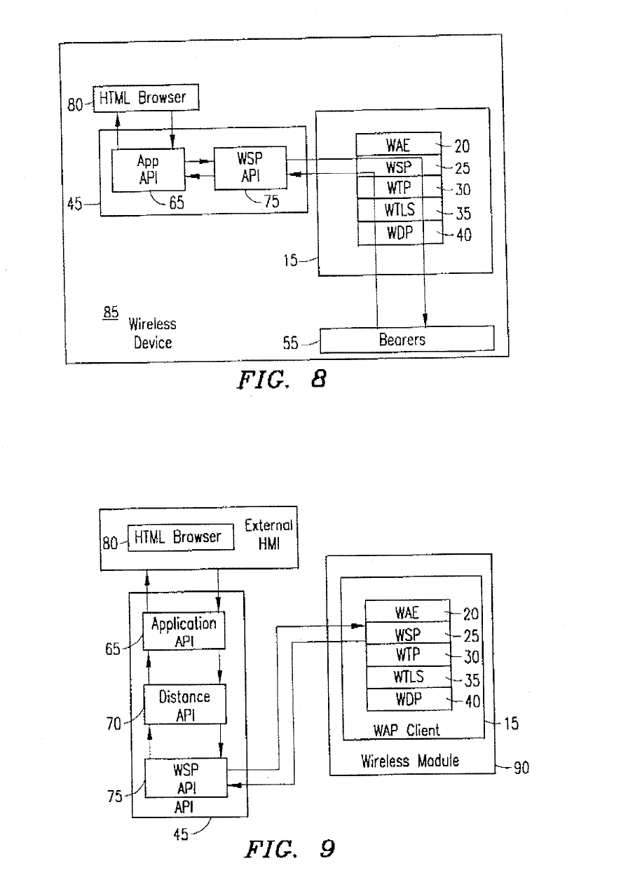

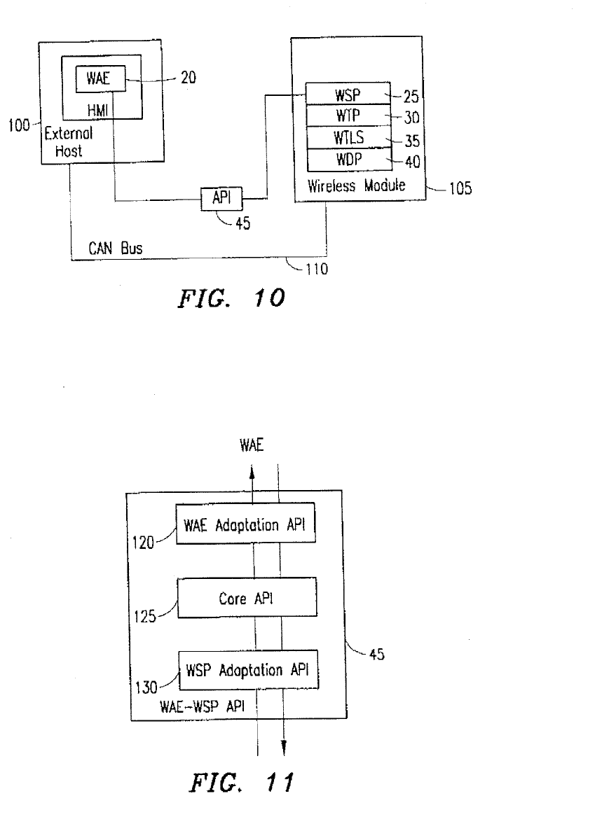

Referring now to FIG. 9, there is illustrated an implementation of the API interface 45 wherein an HTML browser 80 is implemented within an external human machine interface separate from the wireless module 90 containing the WAP protocol stack 10 and the WSP layer 25. In this case, each of the application API layer 65, the distance API layer 70 and the WSP API layer 75 are necessary within the application programming interface 45 to transmit data between the HTML browser 80 and the WSP layer 25.

In another embodiment shown in FIG. 10, the WSP layer 25 may interface with a remotely located WAE layer 20 as the external application environment 60. The WAP client 40 is divided into two parts, the WAE layer 20 and the rest of the WAP stack 10. These entities reside in different locations with the WAE layer 20 residing in an external host 100 and the WAP stack 10 residing within a wireless module 105. These two physical entities may be interconnected by any type of serial link 110 such as a CAN (Control Area Network) bus. The application programming interface 45 is implemented within the WAE 20, WSP layer 25 and the serial link 110 in order to enable communication management between the WAE 20 and the WSP 25. In addition to using a CAN bus for the serial connection between the external host 100 and the wireless module 105, other serial architectures such as a RS-232 interface or other may be utilized.

The WAE 20 comprises the upper layer of the WAP stack 10. It consists of two main elements, the WAE user agent and the WTA user agent. The WAE user agent is responsible for interpreting the WML and WML script content. The WTA user agent permits the WAE to perform telephonic functions. The WAE user agent makes use of normal WSP sessions while the WTA user agent makes use of a specific kind of WSP session called a WTA session. The application programming interface 45 between a separately located WAE layer 20 and WSP layer 25 consists of three separate layers, the WAE adaptation API layer 120, the core API layer 125 and the WSP adaptation API layer 130. The API 45 is symmetric such that communication may be performed in both directions. The API 45 enables normal operations between the WAE layer 20 and the WSP layer 25 and supports WML, WML script and WTA applications.

The WAE adaptation API 120 permits the communication between the WAE layer 20 and the core API layer 125. The WAE adaptation API layer 120 obtains primitives which are leaving the WAE 20 and places them within the right format to transmit to the WSP layer 25 over the serial link 10 interconnecting the WAE 20 and WSP layer 25. Thus, if, for example, the CAN bus serial link is utilized the WAE primitives must be embedded in AT commands or OBEX objects for transmission to the WSP. The WAE adaptation API layer 120 also places content in the correct format for transfer over serial communication between layers. In a reverse direction, the WAE adaptation API layer 120 extracts WSP primitives from the AT command, or OBEX object structure such that the primitive may be passed on to the WAE layer.

The core API layer 125 takes data from the WAE adaptation layer 120 and passes the data to the WSP by means of the WSP adaptation layer 130. The functionality of this layer consists of transporting data in the right format over the serial link interconnecting the WAE and WSP layers. The physical media used to communicate between the WAE layer 20 and the WSP layer 25 is in the described embodiment the CAN bus so the functionality of the WAE adaptation API layer 120 transfers commands using AT commands or OBEX objects. The AT command or OBEX object having the embedded primitives are placed in the correct format at the transmission end and conveyed over the serial link 110. The serial link 110 will have specific characteristics in order to transmit data. The core API layer 125 has these characteristics and can modulate the content to be transmitted over the serial link 110 in a suitable way. At the receiving end, the core API layer 125 makes a demodulation to remove the AT command or OBEX object from the correct format received over the CAN bus. These functions are performed for data passing in both directions.

The WSP adaptation layer 130 receives data from the core API layer 125 exactly as if the data were transferred from the WAE 20. The main functionality of this layer 130 consists of taking out the received primitives from the AT command or OBEX object, or whatever other commonly agreed upon data structure is utilized, so that the primitive interchange between the layers may be completed. This enables the WAE and WSP layers to interact as if they were working in the same physical place. The WSP adaptation API 130 must transfer the content using the corresponding entry point to the WSP. In the reverse direction, the primitives from the WSP layer are embedded in a suitable format such as AT command, OBEX object or other agreed upon transport medium for transmission to the core API 125.

The previous description is of a preferred embodiment for implementing the invention, and the scope of the invention should not necessarily be limited by this description. The scope of the present invention is instead defined by the following claims.

What is claimed is:

1. An application programming interface for interfacing a WSP layer of a WAP protocol stack with an external application environment, comprising:
a first layer associated with the external application environment for mapping primitives of the external application environment received at the first layer into a WSP primitive and into a transport format for forwarding toward the WSP layer and for extracting primitives of the external application environment from the transport format received at the first layer; and
a second layer associated with the WSP layer for mapping primitives of the WSP layer received at the second layer into external application environment primitives and into the transport format for forwarding toward the external application environment and for extracting primitives of the WSP layer from the transport format received at the second layer.

2. The application programming interface of claim 1, further including a transport layer for moving data in the transport format between the first layer and the second layer.

3. The application programming interface of claim 2, wherein the transport layer moves the data over a serial connection.

4. The application programming interface of claim 1, wherein the transport format comprises AT commands.

5. The application programming interface of claim 1, wherein the transport format comprises OBEX objects.

6. The application programming interface of claim 1, wherein the transport format transports data over a serial connection.

7. The application programming interface of claim 1, wherein the external application environment comprises a non-WAP application.

8. The application programming interface of claim 6, wherein the external application environment comprises an HTML browser.

9. The application programming interface of claim 1, wherein the external application environment comprises at least one of a data interpretation program or a data synchronization program.

10. The application programming interface of claim 1, wherein the external application environment comprises a WAE layer of the WAP application at a separate location from the WSP layer.

11. The application programming interface of claim 1, wherein the WSP layer and the external application environment are located in a same device.

12. The application programming interface of claim 1, wherein the WSP layer and the external application environment are located in separate devices.

13. An application programming interface for interfacing a WSP layer of a WAP protocol stack with a non-WAP application environment, comprising:
an application API layer associated with the non application environment for mapping primitives of the external application environment received at the application API layer into a WSP primitive and into a transport format for forwarding toward the WSP layer and for extracting primitives of the non-WAP application environment from the transport format received at the application API layer; and
a WSP API layer associated with the WSP layer for mapping primitives of the WSP layer received at the WSP API layer into non-WAP application environment primitives and into the transport format for forwarding toward the external application environment and for extracting primitives of the WSP layer from the transport format received at the WSP API layer

14. The application programming interface of claim 13, further including a distance API layer for moving data in the transport format between the application API layer and the WSP API layer.

15. The application programming interface of claim 14, wherein the distance API layer moves the data over a serial connection.

16. The application programming interface of claim 13, wherein the transport format comprises AT commands.

17 The application programming interface of claim 13, wherein the transport format comprises OBEX objects.

18. The application programming interface of claim 13 wherein the transport format transports data over a serial connection.

19. An application programming interface for interfacing a WSP layer of a WAP protocol stack with an external WAE layer, comprising:
a WAE adaptation API layer associated with the WAE layer for mapping primitives of the WAE layer received at the WAE adaptation API layer into a transport format for forwarding toward the WSP layer and for extracting primitives of the WSP layer from the transport format received at the WAE adaptation API layer;
a WSP adaptation API layer associated with the WSP layer for mapping primitives of the WSP layer received at the WSP adaptation API layer into the transport format for forwarding toward the WAE layer and for extracting primitives of the WAE layer from the transport format received at the WSP adaptation API layer; and
a core API layer for moving data in the transport format between the WAE adaptation API layer and WSP adaptation API layer.

20. The application programming interface of claim 19, wherein the core API layer moves the data over a serial connection.

21. The application programming interface of claim 19, wherein the transport format comprises AT commands.

22. The application programming interface of claim 19, wherein the transport format comprises OBEX objects.

23. The application programming interface of claim 19 wherein the transport format transports data over a serial connection.

24. An application programming interface for interfacing a WSP layer of a WAP protocol stack with an external application environment, comprising:
logic for converting between primitives of the external application environment and the primitives of the WSP layer.

25 The application programming interface of claim 24, wherein the logic transports the converted primitives between the external application environment and the WSP layer.

26. The application programming interface of claim 24, wherein the logic further comprises:
a first layer associated with the external application environment for mapping primitives of the external application environment received at the first layer into a WSP primitive and into a transport format for forwarding toward the WSP layer and for extracting primitives of the external application environment from the transport format received at the first layer; and
a second layer associated with the WSP layer for mapping primitives of the WSP layer received at the second layer into external application environment primitives and into the transport format for forwarding toward the external application environment and for extracting primitives of the WSP layer from the transport format received at the second layer.

27. The application programming interface of claim 26, further including a transport layer for moving data in the transport format between the first layer and the second layer.

28. An application programming interface for interfacing a WSP layer of a WAP protocol stack with an external application environment, comprising:
a first means associated with the external application environment for mapping primitives of the external application environment received at the first layer into a WSP primitive and into a transport format for forwarding toward the WSP layer and for extracting primitives of the external application environment from the transport format received at the first layer, and
a second means associated with the WSP layer for mapping primitives of the WSP layer received at the second layer into external application environment primitives and into the transport format for forwarding toward the external application environment and for extracting primitives of the WSP layer from the transport format received at the second layer.

29. The application programming interface of claim 28, further including a means for moving data in the transport format between the first means and the second means.

30. A method for interfacing a WSP layer of a WAP protocol stack with an external application environment comprising the steps of:
receiving primitives from the WSP layer and the external application environment;
converting a received primitive between primitives of the WSP layer and the external application environment; and
transporting the converted primitive to either the WSP layer or the external application environment.

31. The method of claim 30, wherein the step of converting further comprises the step of mapping primitives of the external application layer into WSP primitives and into a transport format for forwarding to the WSP layer.

32 The method of claim 30, wherein the step of converting further comprises the step of extracting primitives of the external application environment from the transport format.

33 The method of claim 30, wherein the step of converting further comprises the step of mapping primitives of the WSP layer into external application environment primitives and into a transport format for forwarding to the external application environment.

34. The method of claim 30, wherein the step of converting further comprises the step of extracting primitives of the WSP layer from the transport format.

33. The method of claim 30, wherein the step of converting further comprises the step of mapping primitives of the WSP layer into external application environment primitives and into a transport format for forwarding to the external application environment.

34. The method of claim 30, wherein the step of converting further comprises the step of extracting primitives of the WSP layer from the transport format.

35. A software application for interfacing a WSP layer of a WAP protocol stack with an external application environment comprising:
logic for converting between primitives of the external application environment and the primitives of the WSP layer.

36. The software application of claim 35, wherein the logic transports the converted primitives between the external application environment and the WSP layer.

37. The software application of claim 36, wherein the logic further comprises:
a first layer associated with the external application environment for mapping primitives of the external application environment received at the first layer into a WSP primitive and into a transport format for forwarding toward the WSP layer and for extracting primitives of the external application environment from the transport format received at the first layer; and
a second layer associated with the WSP layer for mapping primitives of the WSP layer received at the second layer into external application environment primitives and into the transport format for forwarding toward the external application environment and for extracting primitives of the WSP layer from the transport format received at the second layer.

38. The software application of claim 37, further including a transport layer for moving data in the transport format between the first layer and the second layer.
